(19) United States
(12) Patent Application Publication
(10) Pub. No.: US 2026/0169887 A1
(43) Pub. Date: Jun. 18, 2026

(54) Performance Variability Optimization

(71) Applicant: Hewlett Packard Enterprise Development LP, Spring, TX (US)

(72) Inventors: Eitan Frachtenberg, Portland, OR (US); Mohammad Sonji, Charlottesville, VA (US); Izzat El Hajj, Riad El Solh (LB); Mohammed Baydoun, Saida (LB)

(21) Appl. No.: 18/986,028

(22) Filed: Dec. 18, 2024

(51) Int. Cl. G06F 11/34; G06F 11/32

(52) U.S. Cl. CPC G06F 11/3452; G06F 11/324; G06F 11/3414

(57) ABSTRACT

Techniques are provided for identifying and/or mitigating performance variability with respect to execution of application over a number of executions. Specifically, performance metrics are obtained for a number of executions of the application until a statistically stable distribution of the performance metrics is attained. Variability and execution factors corresponding to the variability and/or mitigation factors associated with execution factors may be identified and presented, enabling variability reduction for subsequent executions of the application.

### BACKGROUND

The present disclosure relates generally to identifying and reducing variability of computer application performance. More specifically, the present disclosure relates to increasing the consistency of a performance metric in an application by identifying execution factors that cause a variability in the distribution of the performance metric across runs of the application and providing mitigations to reduce the variability.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Application optimization typically includes running an application a limited number of times and analyzing runtime characteristics. For example, code profilers are often used as tools that allow software developers to analyze application performance. More specifically, code profilers are used by software developers to obtain insight into how the application’s code base performs. The software developers may attempt to improve the application’s performance by using the insights obtained from the code profiler to revise the application’s code base.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a block diagram, illustrating components of a performance variability optimization system, in accordance with aspects of the present disclosure;

FIG. 2 is a flowchart depicting a process for optimizing application performance, in accordance with aspects of the present disclosure;

FIG. 3 is a table depicting execution factor data and performance metric data across repetitions of the application, in accordance with aspects of the present disclosure; and

FIG. 4 is a workflow diagram of a process of optimizing application performance, in accordance with aspects of the present disclosure;

FIG. 5 is an example of a graphical user interface depicting a performance metric distribution, in accordance with aspects of the present disclosure;

FIG. 6 is an example of a graphical user interface depicting an execution factor associated with the performance metric distribution, in accordance with aspects of the present disclosure;

FIG. 7 is an example of a graphical user interface depicting mitigation suggestions related to the execution factor associated with the performance metric distribution, in accordance with aspects of the present disclosure;

FIG. 8 is an example of a graphical user interface depicting a comparison of the pre-mitigation performance metric distribution and post-mitigation performance metric distribution, in accordance with aspects of the present disclosure; and

FIG. 9 is an example of a graphical user interface depicting additional functionalities for evaluating the impact that a selected mitigation action has on other aspects of the computer application, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Although code profilers are a useful mechanism for optimizing some applications, advances in hardware and software technology have led to an increasingly complex computer application infrastructure. Consequently, application performance is likely to vary significantly in response to the many possible run-time factors that are a byproduct of various environmental factors, including the infrastructure complexity. It is recognized that techniques to reduce variability in a computer application’s performance provide a benefit in the development and use of computer applications.

The present disclosure relates generally to identifying and reducing variability of application performance. More specifically, the present disclosure relates to increasing the consistency of a performance metric in an application by identifying execution factors that cause a variability in the distribution of the performance metric across runs of the application and providing mitigations to reduce the variability.

The current techniques optimize one or more performance metric(s) of execution (hereinafter “performance metric”) for an application by reducing a variability in the performance metric’s distribution across multiple runs of the application. Indeed, performance metrics (e.g., CPU use, memory use, program run time) are not constant between runs of the application. Because of the growing complexity in the hardware and software found in computing systems and distributed networks, a variety of execution factors may affect a performance metric across runs of the application. It may be desirable to increase the application’s consistency for a selected performance metric by identifying and mitigating the execution factors associated with the variability in the distribution of that performance metric. The execution factors associated with the performance metric may be identified, for example, using a code profiler while the application is running to collect data at different levels of granularity associated with the program’s execution (e.g., from the hardware system level, software system level, and application level). After collecting the execution factor data, computer algorithms, such as statistical or machine-learning algorithms, can be used to identify the relationships between the execution factors and determine which execution factors, or combinations of execution factors, are associated with the variability in the selected performance metric. The execution factors may be any factor associated with execution of an application. For example, the execution factors may be a software system-level performance metric observed during execution of the application, a hardware system-level performance metric observed during execution of the application, and/or an application-level metric observed during execution of the application. Once the execution factors causing the variability are identified, the computing system can suggest hardware and software-based mitigations to reduce the variability for the performance metric.

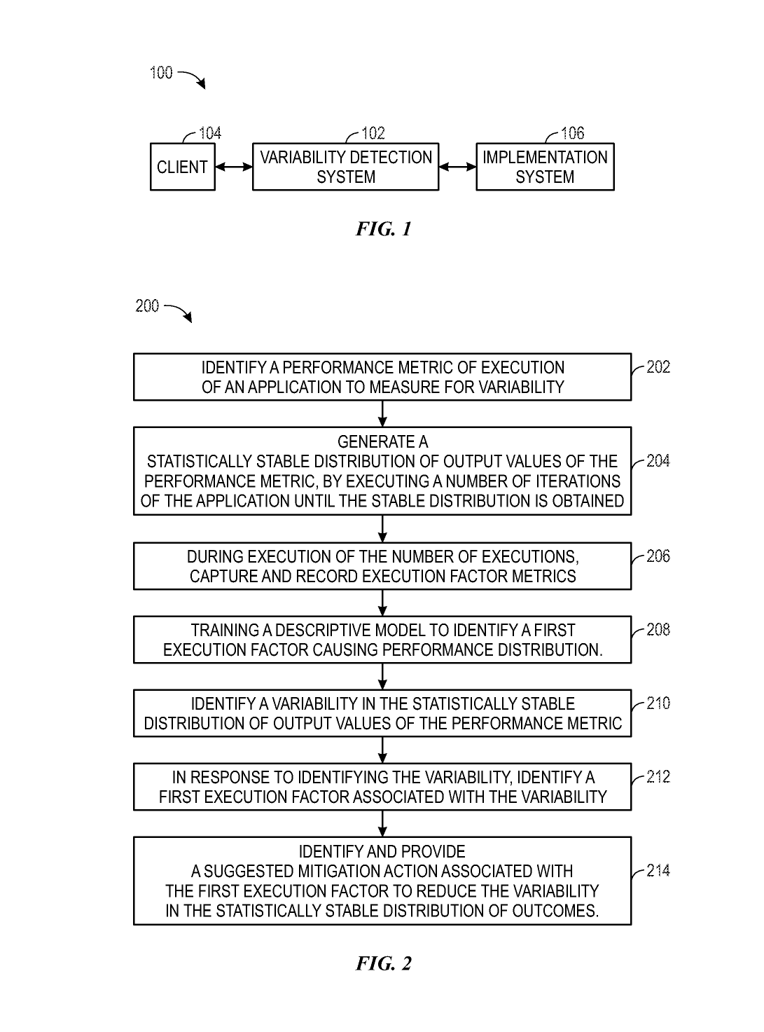

With the preceding discussion in mind, FIG. 1 is a block diagram illustrating a variability optimization system 100, in accordance with aspects of the present disclosure. In the variability optimization system 100, a variability detection system 102 is communicatively connected to a client device 104 and an implementation system 106. The variability detection system 102 may communicate with the client device 104 and the implementation system 106 through hardware connections (e.g., wireline communication) or through any form of network communication (e.g., over the internet).

The client device 104 may be any electronic device capable of performing computing functions. For example, the client device 104 may be a desktop, laptop computer, mobile phone, tablet or the like. Further, the client device 104 may include hardware components such as a display, input/output interfaces, communication circuity, processors, memory, and the like.

The variability detection system 102 and implementation system 106 may include some or all of the preceding computer components. In some embodiments, the variability detection system 102 may include an electronic service hosted on a network (e.g., an internet or cloud-based application).

The implementation system 106 refers to a computer component configurable to run the application to be optimized. For example, the implementation system 106 may refer to a processor on the client device 104 that runs the application locally (e.g., on the client device 104). Alternatively, the client device 104 may initiate an application to be run on one or more separate computing devices (e.g., desktops laptops, mobile phones, tablets), servers, virtual servers, or the like. In this way, the implementation system 106 refers to the hardware or software computing component configurable to process and run the application to be optimized for reduced variability.

Turning now to the optimization process, in some embodiments, the client device 104 initiates or causes evaluation of variability of an application. The application may be any computer program designed to carry out a computing task. Specifically, the client device 104 may request evaluation of variability of a particular performance metric associated with execution of the application over time. This may cause the variability optimization system 100 to execute the application a number of times and collect performance metrics associated with each run until a sufficient amount of collected performance data is obtained to generate a statistically stable distribution of the particular performance metric with respect to the runs. For example, the client device 104 may cause remote execution of the application, by providing an instruction to the implementation system 106, causing the implementation system 106 to execute the application. In other instances, the client device 104 may initiate the application locally (i.e., the application runs on the client device 104). For purposes of this disclosure, a statistically stable distribution is defined as a set of performance metric statistics that do not change beyond a statistical threshold when additional repetitions of the application (i.e., runs) are performed.

The variability detection system 102 is tasked with identifying variability over runs of the application. Thus, as additional runs of the application are executed, the performance metrics associated with these runs may be received (e.g., from the executing components, such as the client device 104 and/or implementation system 106) and aggregated by the variability detection system 102.

After the variability detection system 102 receives and aggregates a threshold amount of performance data (e.g. a performance “data set”) for runs of the application to attain the statistically stable distribution, the variability detection system 102 may perform data analytics on the aggregated performance data, such as categorizing and evaluating data points in the data set. The variability detection system 102 may do this by applying statistical or machine-learning algorithms (e.g., linear regression, neural networks, decision trees) to the data set. Machine-learning algorithms are useful for identifying relationships between the various execution factors and variability within the statistically stable distribution of the performance metric because the relationships may be complex and non-linear.

After identifying the execution factors that have an impact on variability for the selected performance metric, the variability detection system 102 may generate a responsive action for the client device 104. For example, in some embodiments, the variability detection system 102 may notify the client device 104 of execution factors causing a variability. Further, in some cases, the variability detection system 102 may transmit recommendations to affect improvements (e.g., reducing the variability) in the execution factors causing the variability. In some cases, the variability detection system 102 may provide software (e.g., computer readable instructions) to the client device 104 containing software-based mitigations, such as automated configuration adjustment scripts, to alter the execution factors causing the variability and, thus, resolving the performance metric variability. These computer readable instructions may be predefined (e.g., the instructions are stored in a database on the variability detection system 102 or in a network that the variability detection system 102 can access) or they may be generated on the variability detection system 102 in response to the execution factors that cause the variability (e.g., using generative artificial intelligence (AI) and/or machine-learning algorithms).

The client device 104 receives the mitigation suggestions. In some embodiments, the client device 104 may display the suggested mitigations on a graphical user interface (GUI) for user review. In other embodiments, the client device 104 may automatically apply and/or cause automated implementation of the suggested mitigations (e.g., to the application and/or the component tasked with implementing the application, for example, the client device 104 and/or the implementation system 106).

After the mitigation is implemented, the variability detection system 102 may evaluate the recommended mitigation’s effectiveness. To do this, the variability detection system 102 may trigger execution of a number of repetitions of the application to obtain a new statistically stable distribution of the particular performance metric to evaluate for variability. As described above, execution factor data is collected while the application runs. After the application has run and a stable distribution of outcomes for the performance metric has been recorded, the variability detection system 102 may determine if the mitigations were successful in reducing variability for the selected performance metric by comparing the pre-mitigation performance metric distribution to the post-mitigation performance metric distribution. In some embodiments, the variability detection system 102 may suggest other mitigations to substitute and/or supplement the previously recommended mitigations to further reduce variability in the distribution of the performance metric. For example, after a mitigation has been applied, the variability detection system 102 may suggest additional mitigations to reduce the variability. Likewise, the variability detection system 102 may generate new mitigation actions based on the applied mitigation. In this way, the process of reducing variability may proceed iteratively such that as mitigations are rejected or applied, additional mitigations may be provided to continue reducing variability in the distribution of the performance metric.

It should be noted that although the variability optimization system 100 depicted in FIG. 1 illustrates the variability detection system 102, client device 104, and implementation system 106 as separate computing devices, other embodiments are also possible. For example, the disclosed technique for variability optimization can be maintained on one computing device when the variability detection system 102, client device 104, and implementation system 106 are viewed as component functions of the computing device.

FIG. 2 provides a flowchart diagram of a process 200 of the disclosed performance variability optimization techniques. The process 200 beings with identifying a performance metric of execution of an application to measure for variability (block 202). The performance metric, as discussed throughout this disclosure, may refer to any measurable characteristic of an application’s execution. In some cases, the performance metric may refer to a metric measuring hardware and/or software system-level performance. In some cases, the performance metric of execution may refer to metrics measuring performance at the application level. These include, as non-limiting examples, program run times, error rates, throughput, and the like. In sum, performance metric refers to any indicator of application performance that can be measured on a computing device.

In some embodiments, the performance metric may be selected at the client device 104 of FIG. 1. The client device 104, for example, may display a GUI with tables, drop down menus, lists, entry fields, or other input mechanisms configurable to select an affordance selection of the performance metric. In other embodiments, the performance metric may be suggested by the variability detection system 102 of FIG. 1. More specifically, machine-learning algorithms (e.g., deep learning neural networks) may be useful for automatically determining the performance metrics that vary across runs of the application.

At block 204, the process 200 continues by generating a statistically stable distribution of output values of the performance metric by running the application for a number of repetitions. A statistically stable distribution is a set of performance metric statistics that do not change beyond a statistical threshold when additional repetitions of the application are performed. In some embodiments, a statistically stable distribution is achieved by running the program a predetermined number of repetitions (e.g., 30 runs, 150 runs, 400 runs). In other embodiments, algorithms, such as machine-learning algorithms, may calculate the number of runs needed to reach a statistically stable distribution for the performance metric. In some embodiments, the statistically stable number of repetitions may be determined before the client device 104 or implementation system 106 initiates the application. In other embodiments, the number of repetitions of the application that produces a statistically stable number of distributions for the performance metric may be evaluated dynamically. That is, the application may run on a loop with no until a sufficiently stable distribution of outcomes is reached or a maximum limit is exceeded.

During execution of the number of runs of the application, execution factor metrics are captured and recorded (block 206). As used herein, execution factors are any measurable characteristic of the application that can be modified to alter the application’s performance. The execution factor metrics may be recorded for each run of the application using a code profiler. Any type or method of code profiling may be used to record the execution factor metrics. For example, a server-side profiler on the implementation system 106, a desktop profiler on the client device 104, a hybrid profiler on the variability detection system 102, a memory or sampling profiler on the variability detection system 102, the implementation system 106, and/or the client device 104, or the like. Any code profiler that can record execution factors about application performance, system level performance, graphics performance, or any combination of the three may be used. In some embodiments, only one code profiler is used to record execution factor data. Alternatively, in other embodiments, multiple code profilers may be used to record data about a wide range of execution factors.

At block 208, the process 200 continues with training a descriptive model to identify an execution factor causing a distribution in the performance metric. A descriptive model is any computer-based model capable of classifying the execution factor data. For example, there may be thousands, tens-of-thousands, or significantly more execution factors that are relevant to the selected performance metric of the application. Moreover, since the application is running for a number of repetitions, the data set of execution factor metrics may consist of many execution factor data points. The descriptive model performs data analysis on the execution factor data, identifying correlations between execution factors and performance metrics. For example, the descriptive model may evaluate the relationship between combinations of execution factors and the performance metrics to identify causal execution factors likely to cause variability for the particular performance metrics.

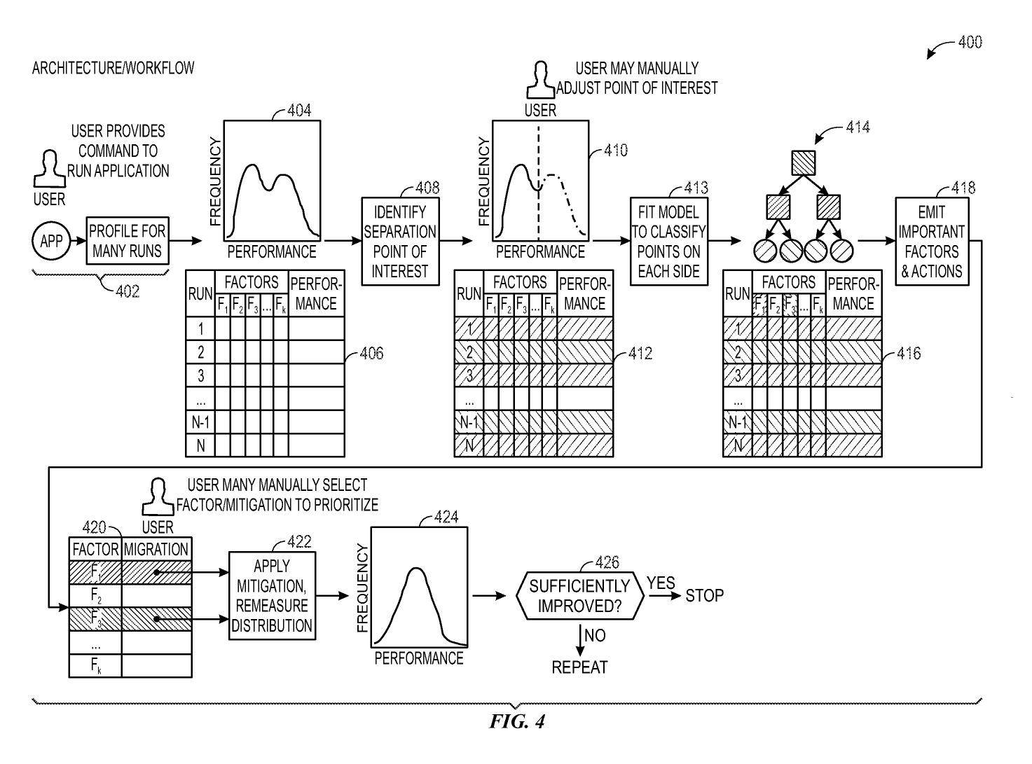

Turning to block 210, the process 200 continues with identifying a variability in the statistically stable distribution of output values of the particular performance metric being evaluated for variability. The variability is a statistical characteristic of the distribution of the performance metric. For example, the variability might be multiple modes in the performance distribution, long tails, or any other statistical variability present in the distribution. As described in more detail with the GUI in FIGS. 4-6, parameters defining the variability to identify may be selected by way of an affordance (e.g., on the client device 104 of FIG. 1). In some embodiments, for example, the GUI may display a graph of the distribution of the performance metric. In other embodiments, a variability point may be identified automatically (e.g., using statistical analysis to identify split modes, longtails, or the like). In some embodiments, the variability may be automatically suggested and then adjusted (e.g., shifted on the GUI via an affordance) by the user.

At block 212, in response to identifying the variability point in the distribution of the performance metric, one or more execution factors associated with the variability may be identified. To identify the one or more execution factors associated with the variability, the execution factor metrics may be applied to the trained descriptive model to identify correlated execution factors for the variability. The descriptive model may engage in supervised or unsupervised machine learning. In some embodiments, the descriptive model may consist of a combination of supervised and unsupervised data analysis functions.

At block 214, the process 200 continues by identifying and providing a suggested mitigation action associated with the one or more causal execution factors causing the variability in the distribution of the performance metric. The mitigation action is a suggested change to the application’s code base intended to affect the execution factor causing the variability in the distribution of the performance metric. In some embodiments, the variability detection system 102 provides human-readable recommended solutions to modify a characteristic of the application and/or the application’s execution in an attempt to reduce the variability associated with one or more execution factors. For example, if the execution factor causing a performance metric (e.g., program run time) to vary is an insufficient allocation of memory, the variability detection system 102 may notify the client device 104 that the lack of memory is an execution factor causing variable runtimes and suggest the user modify the application’s code accordingly. In some cases, computer-readable instructions may be provided for automated implementation. For example, using the same example execution factor deficiency, in some cases, computer code may be automatically generated to reserve more RAM for the application. Using the same example, in other embodiments, the variability detection system 102 may notify the client device 104 that the lack of memory is an execution factor causing variable runtimes and suggest the user modify the application’s code accordingly. In this way, the variability detection system 102 is configurable to respond to any number of execution factors that cause a variability in the performance metric’s distribution.

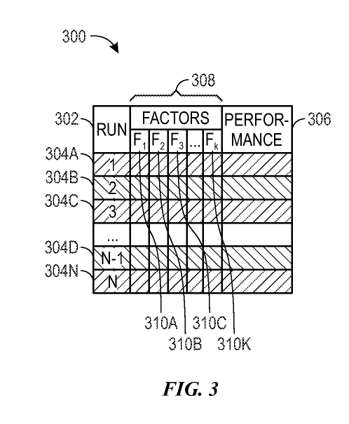

FIG. 3 provides a tabular representation 300 of the metrics that may be recorded for identifying variability and/or causal execution factors of variability. As discussed above, the application runs for a number of repetitions. Each repetition is recorded in a run field 302 (e.g., database column). Records 304A-N illustrate repetition records for a number of runs. In this example, the first record 304A is a record representing the first run of the application and the last record, 304N is a record representing the last run of the application, where N is the total number of runs needed to achieve a statistically stable distribution of outcomes for the performance metric data 306. For each run of the application, the performance metric data 306 is recorded. As discussed above, the distribution of performance metric data 306 is the performance metric evaluated for variability. The factor fields 308 are the execution factors that will be evaluated by the statistical or machine-learning model to determine whether they are causally related to the performance metric distribution. In this example, factor f₁ 310A is the first execution factor associated with the runs. Factor fₖ310K is the last execution factor associated with the runs, where k represents the total number of execution factors that are evaluated for causation with respect to variability of the performance metric data 306.

With the preceding in mind, FIG. 4 is a workflow diagram of a process 400 for optimizing application performance by reducing a variability in a distribution of a performance metric. At 402, a user may initiate an application to run until a statistically stable distribution of outcomes for the selected performance metric is achieved. While the application runs, a code profiler may be used to record execution factor data. The distribution of the performance metric data is represented by a performance distribution graph 404, which may be displayed on a GUI. Likewise, the performance metric data and execution factor data may be represented in a data structure, such as the performance distribution table 406, which also may be displayed on the GUI.

At 408, a separation point of interest is identified. The separation point of interest may be identified by a user selection on the performance distribution graph 410 (e.g., via an affordance for moving the separation line on the GUI). In other embodiments, the separation point of interest may be automatically identified (e.g., via a statistical analysis). In this example, the performance metric data is distributed modally. Resultingly, the separation point of interest has been selected as the dip between the two modes. This separation point is further depicted in the updated performance distribution table 412, which may be reorganized, color coded, or the like in response to the classification.

At 406, a model may be fit to classify points on each side of the identified separation point. For example, a descriptive model 414 may be generated that provides factors associated with each side of the identified separation point, enabling factor patterns between each side of the identified separation point to be identified.

For example, the descriptive model 414 may be used to perform data analysis, such as classifying performance metric data on both sides of the separation point. For example, a decision tree of the descriptive model 414 may be used to classify and analyze the execution factor data. As discussed with reference to block 208 in FIG. 3, however, any machine-learning algorithm may be used to classify the execution factors impacting the performance distribution.

Some execution factors may have little or no causal impact on the distribution of the performance metrics. The execution factors associated with the distribution in the performance metric may be depicted in the updated performance distribution table 416 (e.g., via color coding). Conversely, the execution factors that are not associated with the distribution of the performance metrics, because of the lack of causal connection, may be identified by the descriptive model and omitted from the distribution variability analysis 418. For example, the descriptive model may determine that a set of execution factors are not causes of the performance metric distribution; this set of execution factors may be removed from a set of influential factors of the descriptive model 414 (e.g., a decision tree). Conversely, the execution factors with a causal relationship to the distribution may be subject to a mitigation suggestion. These execution factors may be presented to the user, for example, by a chart 420. The execution factors may be presented in order of priority. That is, the execution factors that are identified as having the greatest impact on the performance distribution may be the first mitigations presented to the user (e.g., f₁ in the chart 420 had a greater impact on the performance metric distribution than f₃). The user may manually select a mitigation action, for example, by selecting the mitigation action from a drop-down menu on the GUI. Alternatively, the descriptive model may identify the likelihood that the mitigation actions will reduce performance variability and the mitigation actions may be suggested to the user based on their likelihood of causing a desired change in the variability of the performance metric.

At block 422, the selected mitigation action may be applied to the application. That is, the mitigation action may be executed, such that the performance metric variability of subsequent runs of the application may be remeasured. The mitigation action may include any number of implementation adjustments with respect to the application. For example, in some cases, thread caching may be implemented to optimize memory allocation under multithreading. Other mitigations, for example, may include: rearranging code functions or data structures for improved cache performance; converting branches in the code to branch-free operations to reduce speculative-execution variability; replacing the underlying memory allocator with one that results in reduced paging variability at the operating system (OS); changing the OS scheduler policy to reduce variability stemming from scheduling decisions; changing relative process priorities to reduced unsynchronized inter-process communication, and others..

After the mitigation action is applied to the application at block 422, the variability distribution may be remeasured by reinitiating the application for a number of repetitions. The number of repetitions may be, for example, the same number of repetitions occurring at 402. Alternatively, the number of repetitions may be a different number of repetitions that results in a statistically stable distribution of outcomes for the performance metric. The post-mitigation distribution 424 of the performance metric may then be compared to the pre-mitigation distribution. For example, a user may determine whether the undesirable statistical characteristic of the pre-mitigation distribution was reduced or resolved by the selected mitigation action. Alternatively, computer algorithms (e.g., machine-learning models) may be used to determine whether the selected mitigation action sufficiently reduced the variability in the performance distribution.

At decision block 426 it is determined whether the performance variability has sufficiently improved when compared with the pre-mitigation action distribution. If the performance distribution was improved (e.g., because the variability in the distribution was reduced by the selected mitigation action), the process 400 may stop, resulting in the mitigation action being implemented for subsequent runs of the application.

However, if the mitigation action is insufficient (e.g., does not provide a desired level of reduction in variability when compared to a threshold), additional mitigation actions or alternative mitigation actions may be tried to further reduce variability in the performance metrics distribution. Thus, the process 400 may be repeated. For example, the process 400 may continue with additional mitigations being selected at 420. Alternatively, the process 400 may completely restart at 402 for the same performance metric or a different performance metric. Further, the process 400 may restart at any other portion in the workflow, such as selecting a different mitigation factor to be applied for evaluation via remeasuring of the variability distribution (block 422). In this manner, different mitigation actions affecting different mitigation factors and/or different combinations of mitigation actions may be evaluated until a desired outcome is observed.

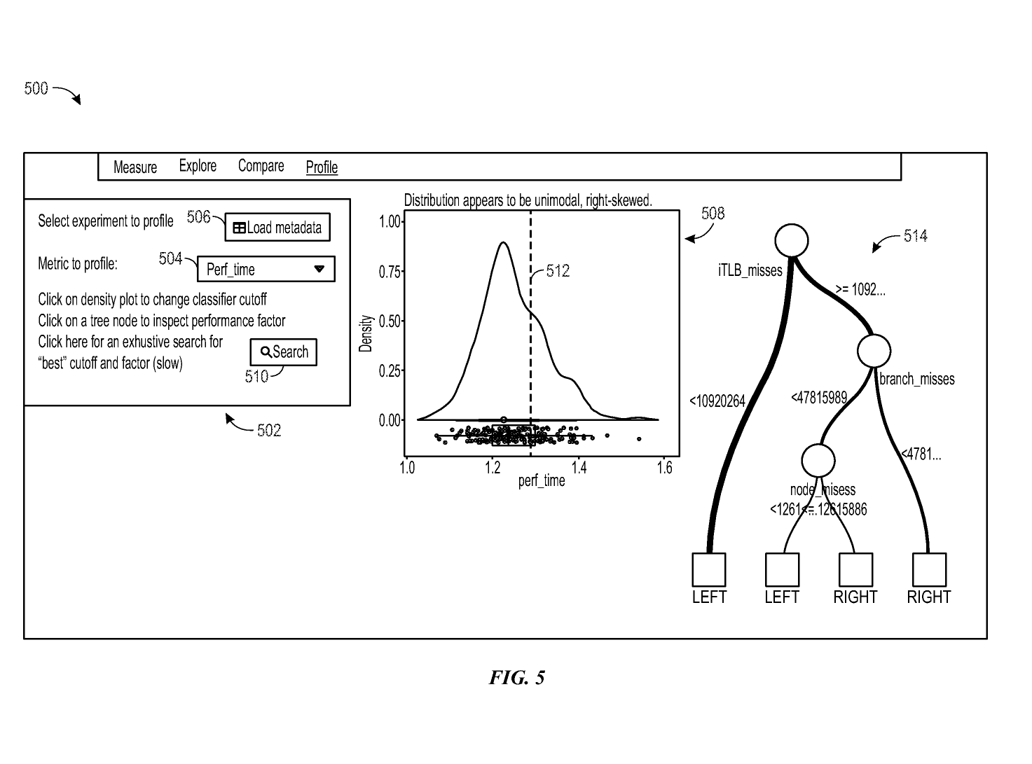

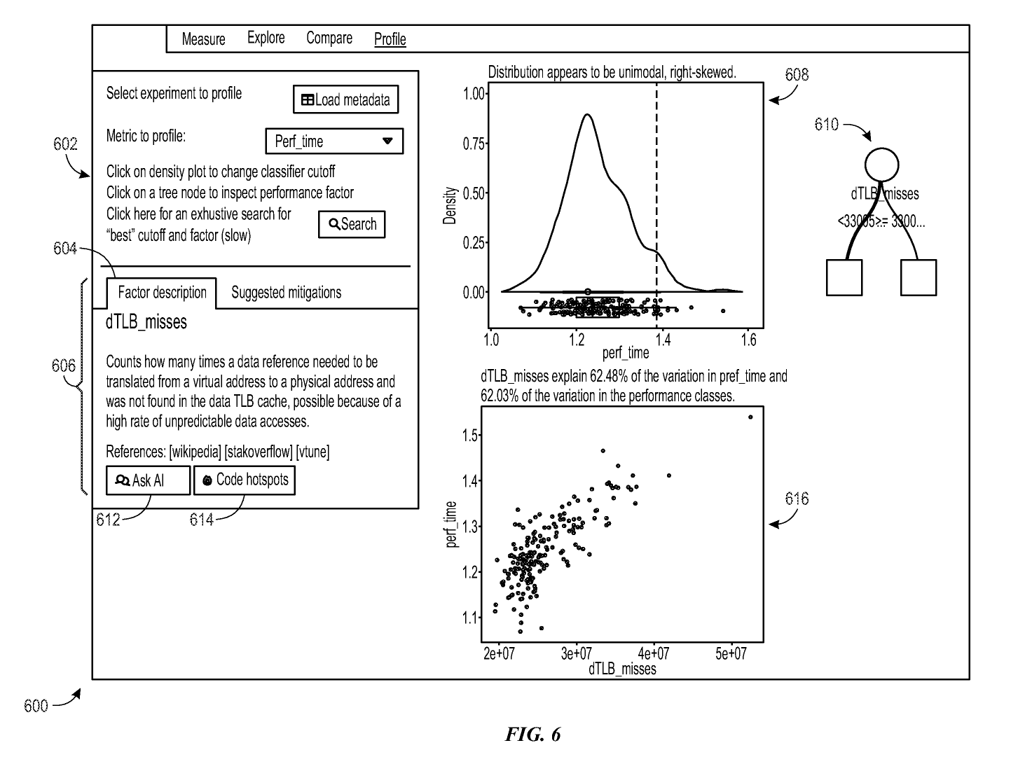

Turning now to an example depiction of the disclosed process, FIGS. 6-9 provide different stages of a GUI that facilitates the techniques described herein. FIG. 5 is an example GUI 500 depicting a performance metric distribution. The GUI includes a panel 502 containing information about the computer application. The panel 502 may also include fields and buttons configured to be responsive to user interaction. The performance metric field 504 enables selection of a performance metric to evaluate for variability. In this example, the performance metric field 504 being evaluated is run time as measured by a tool called “perf” (perf_time). The performance metric field 504 has a drop-down function that allows a user to change the performance metric if desirable. When a different performance metric is selected via the performance metric field 504, a different distribution for the selected performance metric may be presented via the GUI 500 for variability analysis.

An affordance 506 may be used to enable selection of an application to initiate. For example, the affordance 506 may launch a prompt enabling specification of an application to evaluate for variability with respect to the performance metric selected by the performance metric field 504. Upon selection of an application and performance metric, execution of the application may be automatically initiated for a number of repetitions (i.e., until a statistically stable distribution for the performance metric is achieved) while activating a code profiler to compile (e.g., record and aggregate) the execution factor metrics and associated performance metrics observed during the repetitions (e.g., identified based upon the selection of the performance metric field 504). Execution of new repetitions of the application may continue until the observed performance metrics converge into a statistically stable distribution.

The performance distribution 508, indicating the distribution of the performance metrics is depicted in a graph. In this example, the performance distribution 508 is unimodal and right skewed. The “Search” button 510, when selected, may perform a search within the distribution to identify thresholds of variation and corresponding execution factors corresponding to breaches of the identified threshold(s) that may be associated with the breach(es). To perform the search, the system may activate a descriptive model to identify a separation point 512 in the performance distribution 508. The separation point may be a point where the evaluated performance metric has increased variability from the rest of the distribution. Likewise, the separation point 512 may be a point with a strong statistical indication of correlation or causality between one or more execution factors and variability in the performance distribution 508. The separation point 512 may be identified, for example, by an iterative function or by using a heuristic (e.g., a gradient dissent). The separation point 512 is represented on the performance distribution 508 by the dotted vertical line.

A decision tree 514 is depicted in the GUI 500. The decision tree 514 may illustrate the execution factors present during particular portions of the distribution, illustrating a potential influence of the execution factors with respect to the performance-metric distribution. The nodes in the decision tree 514 may represent execution factors that were compiled by the code profiler and analyzed by the descriptive model, resulting in performance metrics occurring on a particular side of the separation point 512. For example, the top node, instruction translation lookaside buffer misses (iTLB_misses) indicates a branch of misses less than 10920264 suggesting performance on the left side of separation point 512. When above this threshold of misses, additional execution factors may be considered to identify when execution will fall on the left side or the right side of the separation point 512. For example, when branch_misses are less than 47815989, then node_misses may determine whether the execution falls on the left side or the right side of the separation point 512. However, when branch_misses are greater than or equal to 47815989, the execution’s performance is always on the right side of the separation point 512.

In some embodiments, the user may interact with the decision tree 514 (e.g., by clicking on one of the nodes to obtain more information about the execution factor represented by that node). For example, particular execution metrics associated with a selected node may be displayed upon selection of a particular mode. As discussed with reference to block 208 of FIG. 2, other descriptive models may be used and presented on the GUI 500.

FIG. 6 is a progression 600 of the GUI 500 depicting an execution factor, which has been identified as a cause of the performance metric distribution in response to searching performed via the GUI 500 of FIG. 5 (e.g., via selection of the “Search” button 510 in FIG. 5). In progression 600, the GUI panel 602 now includes a “Factor Description” tab 604, which causes the GUI panel 602 to display an execution factor subsection 606. The execution factor subsection 606 includes information about one or more of the execution factors corresponding to the distribution in the performance metric. In this example, data translation lookaside buffer misses (dTLB_misses) has been identified as a selected execution factor causing the variability in performance metric distribution 608. The selected execution factor may be represented as a node 610 of the decision tree (514 in FIG. 5). In some embodiments, for example, the user may be able to select a node 610 such that the associated execution factor is displayed in the execution factor subsection 606. In this example, the selected node 610 is the data translation lookaside buffer misses (dTLB_misses) execution factor.

The execution factor subsection 606 includes an explanation of the execution factor. The execution factor subsection 606 may include additional interactive buttons and fields, such as an “Ask AI” button 612 and a “Code Hotspots” button 614. The “Ask AI” button 612 may use machine-learning algorithms to provide further explanation and detail regarding the execution factor. The “Code Hotspots” button 614 identifies and displays the subsections in the computer application’s code in which the execution factor is active and/or believed to be impacting the execution factor (e.g., here, increasing dTLB_misses).

The progression 600 also includes a scatter graph 616. The scatter graph 616 plots the performance metric (e.g., perf_time) against the selected execution factor (e.g., dTLB_misses). The scatter graph 616 provides the user with a visual representation of the impact of the relationship between the selected execution factor and the performance distribution as each point on the scatter graph 616 represents one run of the application. In this manner, a visual representation of the performance-metric distribution to the execution factor may be presented for further analysis.

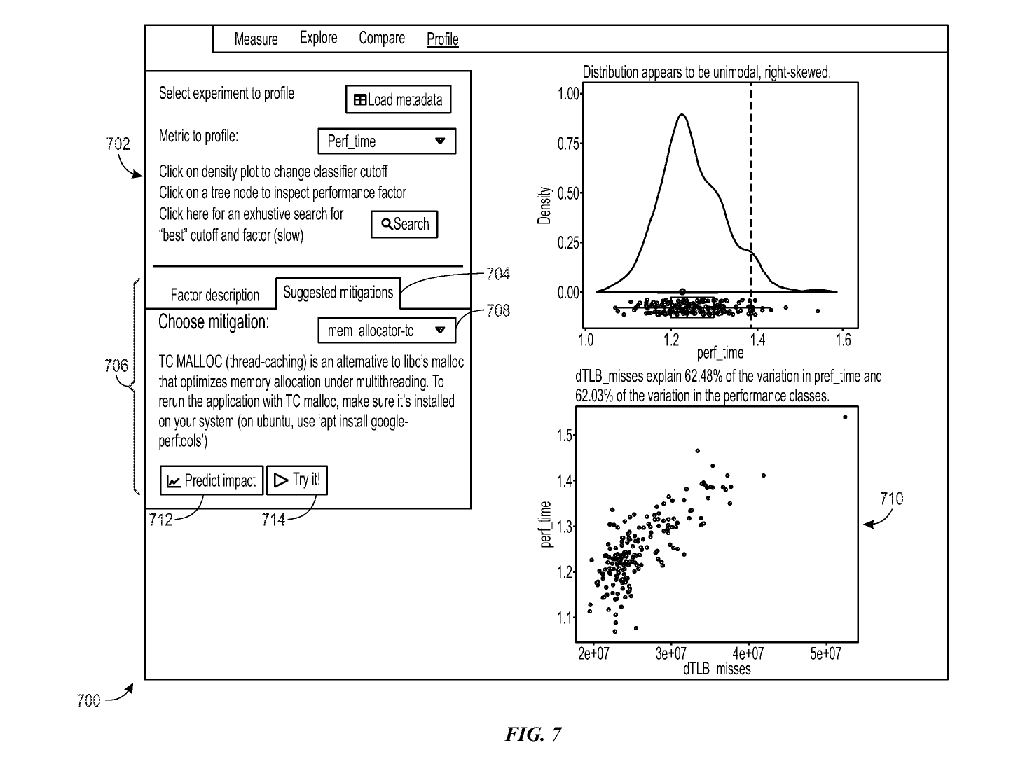

FIG. 7 is another progression 700 of the GUI 500 of FIG. 5 showing suggested mitigations to the execution factor that has been identified as a cause of the performance metric distribution after searching has been performed. In progression 700, the user has selected the “Suggested Mitigations” tab 704. The “Suggested Mitigations” tab 704 includes a mitigations subsection 706. The mitigations subsection 706 includes one or more mitigation actions 708, which are associated with the selected/identified execution factor. In this example, the mitigation action 708 is presented in a drop-down field with one or more other mitigation action candidates. Thus, the user may be able to select one or more mitigation action 708 from a plurality of mitigation actions 708. Here, the selected mitigation action 708 is thread-caching memory allocation (mem-allocator-tc), which is a mitigation specific to the data translation lookaside buffer misses execution factor depicted in the scatter plot 710.

The mitigations subsection 706 may include a description of this suggested mitigation. Likewise, the mitigations subsection 706 may also include a “Predict Impact” button 712 and a “Try It” button 714. The “Predict Impact” button 712 may display an estimated performance metric distribution after the mitigation action has been performed. This estimated performance metric distribution may be generated, for example, by using machine-learning models.

The “Try It” button 714, when selected, results in actual testing of the mitigation action. To do this, the system may reinitiate/re-execute the application. As discussed with reference to block 422 in FIG. 4, the number of runs that the program is initiated for after the mitigation action is applied may vary. After the mitigation action has been applied and the application has run for the specified number of runs, the user will be able to see the actual distribution of the performance metric for the application after applying the suggested mitigation. Re-execution metrics associated with execution via the “Try It” button 714 are not compiled into historical metrics used in generating the statistically stable distributions unless the suggested mitigation is committed for future use in the execution of the application. In this manner, evaluation of mitigation actions will not affect compiled distributions and/or factors until the mitigation action is selected as a desired mitigation action for future execution of the application. In some cases, upon such selection of a mitigation action, the performance metrics and/or execution factors compiled for the application’s execution may be reset, enabling new performance metric distributions to be identified after implementation of the mitigation action(s).

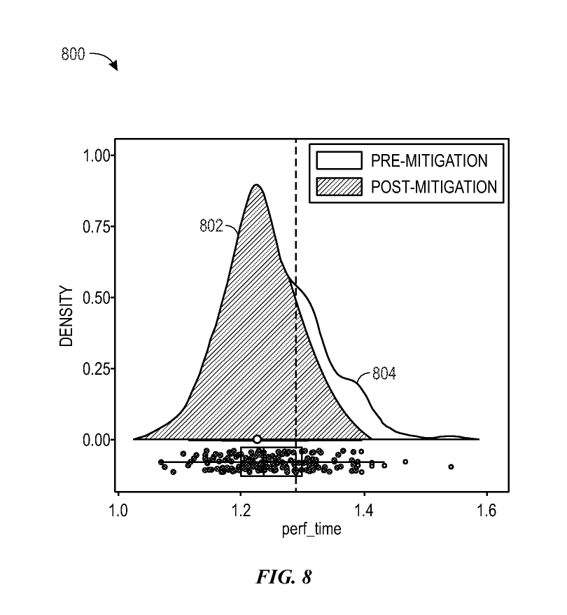

FIG. 8 depicts a GUI 800 that illustrates a comparison between the pre-mitigation performance metric distribution 802 and post-mitigation performance metric distribution 804. The comparative features depicted herein may be responsive to the user selecting the “Predict Impact” button 712 or “Try It” button 714 depicted in FIG. 7. This functionality provides an easy-to-interpret visualization of how successful the mitigation action was in reducing variability in the distribution of the performance metric. In this example, the mitigation successfully decreased the “right skew” of the pre-mitigation performance metric distribution 802. Occasionally, however, the mitigation may be unsuccessful, cause the variability to be reduced by an insufficient margin, or cause the variability to be reduced to a satisfactory margin while causing an undesirable impact to the application’s performance (e.g., variability in the performance metric of application runtime is reduced but mean performance runtime is undesirably increased). As discussed with reference to decision block 426 in FIG. 4, in such cases, a different mitigation action may be selected and/or combined with the current mitigation action to further reduce variability. Thus, many mitigation actions and/or mitigation action combinations may be tried until a desired impact is observed with respect to the performance distribution.

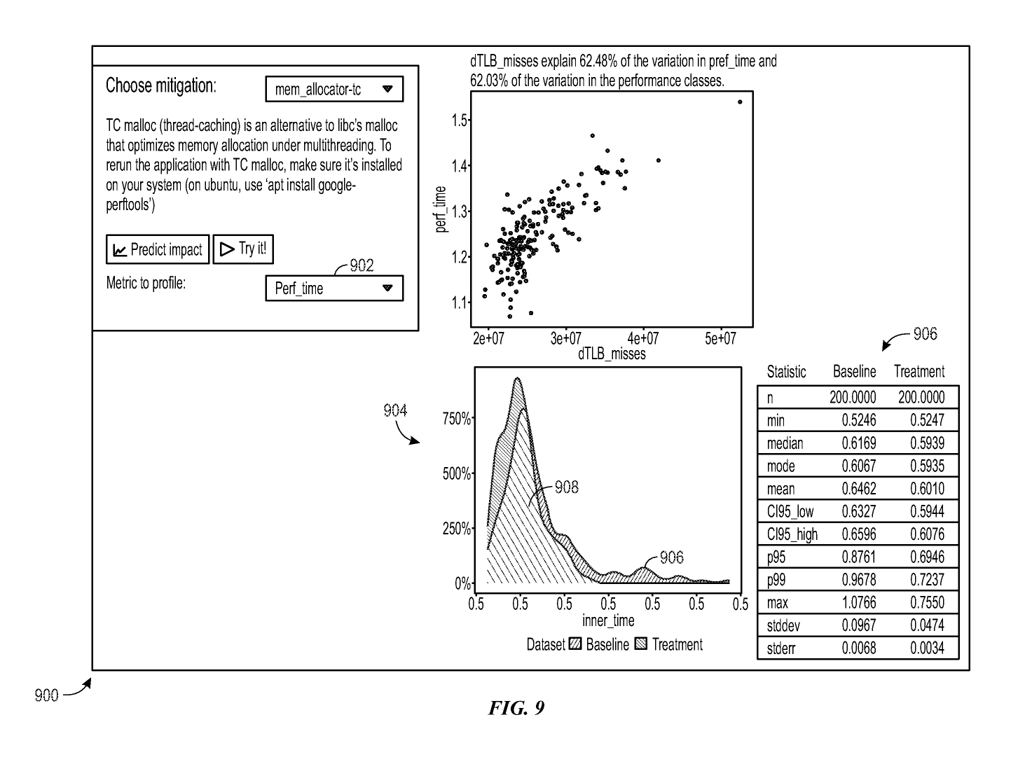

FIG. 9 depicts a GUI 900 after the mitigation action has been implemented. In some cases, applying the mitigation action to the application may impact other aspects of the application’s performance (e.g., performance metrics). The “Metric to Compare” field 902 allows the user to obtain a more comprehensive view of how the selected mitigation impacts the computer application. As presented herein, an additional graph 904 may display the pre-mitigation distribution 906 for the selected comparison metric against the post-mitigation distribution 908 for the selected comparison metric. This functionality allows the user to determine whether the selected mitigation action had any undesirable effect on other aspects of the application. As discussed with reference to decision block 426 in FIG. 4, the user may assess the comparison metric distribution and terminate the process, select a different mitigation action, or continue with the selected mitigation action and select additional mitigation factors to continue the process.

As may be appreciated, the current techniques provide significant value. Specifically, the current techniques provide a performance-metric analysis tool that identifies variability across multiple executions of an application. Further, the current techniques may identify corresponding execution factors present when varied performance metrics were observed, enabling efficient identification of these execution factors and mitigation actions that may counteract the varied performance.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A non-transitory, computer-readable medium, comprising computer-readable instructions that, when executed by one or more processors of one or more computers, cause the one or more computers to:
identify a performance metric of execution of an application to measure for variability;
generate a statistically stable distribution of output values of the performance metric, by executing a number of repetitions of the application until the statistically stable distribution is obtained;
during execution of the number of repetitions, capture and record execution factor metrics using a code profiler;
identify a variability in the statistically stable distribution of output values of the performance metric;
in response to identifying the variability, identify a first execution factor associated with the variability, by applying the execution factor metrics to a machine learning (ML) model; and
identify and provide a mitigation action associated with the first execution factor to reduce the variability in the statistically stable distribution of outcomes.

2. The non-transitory, computer-readable medium of claim 1, comprising computer-readable instructions that, when executed by the one or more processors of the one or more computers, cause the one or more computers to:
identify the variability by identifying a separation point in the statistically stable distribution of output values, the separation point indicating the variability.

3. The non-transitory, computer-readable medium of claim 1, comprising computer-readable instructions that, when executed by the one or more processors of the one or more computers, cause the one or more computers to:
apply the mitigation action associated with the first execution factor and generate a mitigated statistically stable distribution of output values of the performance metric, by, after applying the mitigation action, re-executing a number of repetitions of the application until the mitigated statistically stable distribution is obtained; and
identify an impact of the mitigation action, by comparing the statistically stable distribution with the mitigated statistically stable distribution.

4. The non-transitory, computer-readable medium of claim 3, comprising computer-readable instructions that, when executed by the one or more processors of the one or more computers, cause the one or more computers to:
identify a second execution factor associated with the variability; and
identify and provide a second mitigation action associated with the second execution factor to reduce the variability.

5. The non-transitory, computer-readable medium of claim 4, comprising computer-readable instructions that, when executed by the one or more processors of the one or more computers, cause the one or more computers to:
determine that the impact of the mitigation action does not sufficiently improve the variability; and
in response to determining that the impact of the mitigation action does not sufficiently improve the variability, identify and provide the second mitigation action.

6. The non-transitory, computer-readable medium of claim 1, wherein the first execution factor is at least one of: a system-level performance metric observed during execution of the application, an application-level metric observed during execution of the application, or a graphics system level performance metric observed during execution of the application.

7. The non-transitory, computer-readable medium of claim 1, comprising computer-readable instructions that, when executed by the one or more processors of the one or more computers, cause the one or more computers to:
generate a graphical user interface (GUI) comprising an affordance enabling selection of the performance metric to measure for variability, the affordance comprising a menu of a plurality of performance metrics of execution; and
receive an indication of a selection, via the affordance of the GUI, of the performance metric of execution from the menu.

8. The non-transitory, computer-readable medium of claim 1, comprising computer-readable instructions that, when executed by the one or more processors of the one or more computers, cause the one or more computers to:
generate a graphical user interface displaying the statistically stable distribution of outcomes; and
generate, in the GUI, an affordance to select a separation point in the statistically stable distribution of outcomes, the separation point comprising a parameter to identify the variability;
receive an indication of a selection, via the affordance of the GUI, of the separation point; and
identify the variability based upon the separation point.

9. A computer-implemented method, comprising:
identifying a performance metric of execution of an application to measure for variability;
generating a statistically stable distribution of output values of the performance metric, by executing a number of repetitions of the application until the statistically stable distribution is obtained;
during execution of the number of repetitions, capturing and recording execution factor metrics using a code profiler;
identifying a variability in the statistically stable distribution of output values of the performance metric;
in response to identifying the variability, identifying a first execution factor associated with the variability, by applying the execution factor metrics to a machine learning (ML) model; and
providing an indication of the identified first execution factor and the variability in the statistically stable distribution of outcomes.

10. The computer-implemented method of claim 9, comprising:
identifying a separation point in the statistically stable distribution of output values; and
identifying the variability based upon the separation point.

11. The computer-implemented method of claim 10, comprising:
identifying the first execution factor based upon the first execution factor occurring during a portion of executions associated with a particular side of the separation point indicating the variability.

12. The computer-implemented method of claim 9, comprising:
identifying and providing a mitigation action associated with the first execution factor to reduce the variability in the statistically stable distribution of outcomes, wherein the first execution factor is at least one of: a hardware system-level performance metric observed during execution of the application, a software system-level performance metric observed during execution of the application, or an application-level metric observed during execution of the application.

13. The computer-implemented method of claim 12, comprising:
applying the mitigation action associated with the first execution factor and generating a mitigated statistically stable distribution of output values of the performance metric, by, after applying the mitigation action, re-executing a number of repetitions of the application until the mitigated statistically stable distribution is obtained; and
identifying an impact of the mitigation action, by comparing the statistically stable distribution with the mitigated statistically stable distribution.

14. The computer-implemented method of claim 13, comprising:
identifying a second execution factor associated with the variability; and
identifying and providing a second mitigation action associated with the second execution factor to reduce the variability.

15. The computer-implemented method of claim 14, comprising:
determining that the impact of the mitigation action does not sufficiently improve the variability; and
in response to determining that the impact of the mitigation action does not sufficiently improve the variability, identifying and providing the second mitigation action.

16. The computer-implemented method of claim 9, comprising:
generating a graphical user interface (GUI) comprising an affordance enabling selection of the performance metric to measure for variability, the affordance comprising a menu of a plurality of performance metrics of execution; and
receiving an indication of a selection, via the affordance of the GUI, of the performance metric of execution from the menu.

17. The computer-implemented method of claim 9, comprising:
generating a graphical user interface (GUI) displaying the statistically stable distribution of outcomes;
generating, in the GUI, an affordance to select a separation point in the statistically stable distribution of outcomes, the separation point comprising a parameter to identify the variability;
receiving an indication of a selection, via the affordance of the GUI, of the separation point; and
identifying the variability based upon the separation point.

18. A system, comprising:
an application implementation system configured to implement executions of an application; and
a variability detection system comprising hardware configured to:
identify a performance metric of execution of the application to measure for variability;
identify a statistically stable distribution of output values of the performance metric, by causing executing a number of repetitions of the application by the application implementation system until the statistically stable distribution is obtained;
during execution of the number of repetitions, capture and record execution factor metrics using a code profiler;
identify a variability in the statistically stable distribution of output values of the performance metric;
in response to identifying the variability, identify a first execution factor associated with the variability, by applying the execution factor metrics to a machine learning (ML) model; and
provide an indication of the identified first execution factor and the variability in the statistically stable distribution of outcomes in a graphical user interface (GUI).

19. The system of claim 18, wherein the variability detection system is configured to:
identify and provide a mitigation action associated with the first execution factor to reduce the variability in the statistically stable distribution of outcomes, wherein the first execution factor is at least one of: a hardware system-level performance metric observed during execution of the application, a software system-level performance metric observed during execution of the application, or an application-level metric observed during execution of the application.

20. The system of claim 19, wherein the variability detection system is configured to:
implement the mitigation action via the application implementation system;
re-causing executing of the number of repetitions of the application by the application implementation system until a second statistically stable distribution is obtained; and
provide via the GUI a comparison of the statically stable distribution and the second statically stable distribution, illustrating an effectiveness of the implemented mitigation action.
